(19) United States
(12) Patent Application Publication
(10) Pub. No.: US 2023/0188016 A1
(43) Pub. Date: Jun. 15, 2023

(54) DRONE MOTOR

(71) Applicant: EXEDY Corporation, Osaka (JP)

(72) Inventors: Takashi IMOTO, Osaka (JP); Kohsuke MURATA, Osaka (JP); Yoshifumi SHIMOGAKI, Osaka (JP)

(21) Appl. No.: 17/984,407

(22) Filed: Nov. 10, 2022

(30) Foreign Application Priority Data
Dec. 10, 2021 (JP) 2021-200738

(51) Int. Cl. H02K 15/14; B64C 39/02; H02K 1/2786

(52) U.S. Cl. CPC H02K 15/14; B64C 39/024; H02K 1/2786; B64C 2201/042

(57) ABSTRACT

A drone motor includes a housing, a punching plate, a rotor, and a stator. The housing includes a top plate provided with an opening. The punching plate is attached to the top plate so as to cover the opening. The rotor is rotatably disposed inside the housing. The stator is non-rotatably disposed inside the housing.

### CROSS-REFERENCE TO RELATED APPLICATIONS

This application claims priority to Japanese Patent Application No. 2021-200738 filed Dec. 10, 2021. The entire contents of that application are incorporated by reference herein in their entirety.

### TECHNICAL FIELD

The present invention relates to a drone motor.

### BACKGROUND ART

Drones have begun to prevail in recent years. In general, a drone includes a body, a plurality of arms extending from the body in a radial shape, and a plurality of motors attached to the distal ends of the arms, respectively. The motors rotate propellers, respectively. This type of drone motor includes a housing that accommodates a rotor and a stator (see Specification of United States Patent Application Publication No. US 2019/0181701).

Such a drone motor configured as described above is demanded to be lightweight and be dustproof enough to be durable even for outside use. However, being lightweight and being dustproof are in a conflict relation as features of the drone motor structure. In view of this, it is an object of the present invention to provide a drone motor that can be made lightweight, while being kept dustproof.

### BRIEF SUMMARY

A drone motor according to an aspect of the present invention includes a housing, a punching plate, a rotor, and a stator. The housing includes a top plate provided with an opening. The punching plate is provided with a plurality of through holes. The punching plate is attached to the top plate so as to cover the opening. The rotor is rotatably disposed inside the housing. The stator is non-rotatably disposed inside the housing.

According to this configuration, the top plate is provided with the opening; hence, the drone motor can be made lightweight. Besides, the opening is covered with the punching plate; hence, a foreign object can be inhibited from intruding into the housing.

Preferably, the punching plate is attached to an inner surface of the top plate.

Preferably, the top plate includes a plurality of swaging portions fixing the punching plate.

Preferably, the top plate includes a plurality of arms. The plurality of arms radially extend. The plurality of arms are circumferentially disposed apart from each other at intervals. The opening is disposed between circumferentially adjacent two of the plurality of arms. The plurality of swaging portions are identical in a circumferential position to the plurality of arms.

Preferably, the punching plate includes a plurality of swaged regions. The plurality of swaged regions are regions that are not provided with the plurality of through holes formed by punching and are contacted by the plurality of swaging portions.

Preferably, the top plate includes a first cylindrical portion and a second cylindrical portion. The first cylindrical portion axially extends. The second cylindrical portion axially extends. The second cylindrical portion is disposed radially outside the first cylindrical portion. The punching plate is disposed between the first and second cylindrical portions.

Preferably, the plurality of swaging portions are formed by bending in part at least one of the first and second cylindrical portions.

Preferably, the top plate includes a top plate body and an outer cylindrical portion. The top plate body is provided with the opening. The outer cylindrical portion axially extends from an outer peripheral end of the top plate body.

Preferably, the outer cylindrical portion has a taper shape.

Preferably, the rotor includes a yoke having an annular shape and a plurality of magnets. The yoke is fixed to an inner peripheral surface of the outer cylindrical portion. The yoke axially protrudes from the outer cylindrical portion. The plurality of magnets are fixed to an inner peripheral surface of the yoke.

Preferably, the punching plate is lesser in thickness than the top plate.

Preferably, the top plate is disposed to be rotatable with the rotor.

Each of the plurality of through holes of the punching plate can be set to have a maximum dimension less than or equal to a dimension of a gap between the rotor and the stator. Preferably, the maximum dimension of each through hole of the punching plate is less than or equal to a dimension enabling each through hole to block intrusion of a foreign object into the housing.

Preferably, the drone motor further includes a rotational shaft. The rotational shaft penetrates the top plate so as to axially extend from inside to outside the housing.

Overall, according to the present invention, the drone motor can be made lightweight.

### BRIEF DESCRIPTION OF THE DRAWINGS

FIG. 1 is a cross-sectional view of a drone motor.

FIG. 2 is a cross-sectional view of a top plate.

FIG. 3 is a plan view of the top plate.

FIG. 4 is a plan view of a punching plate.

### DETAILED DESCRIPTION

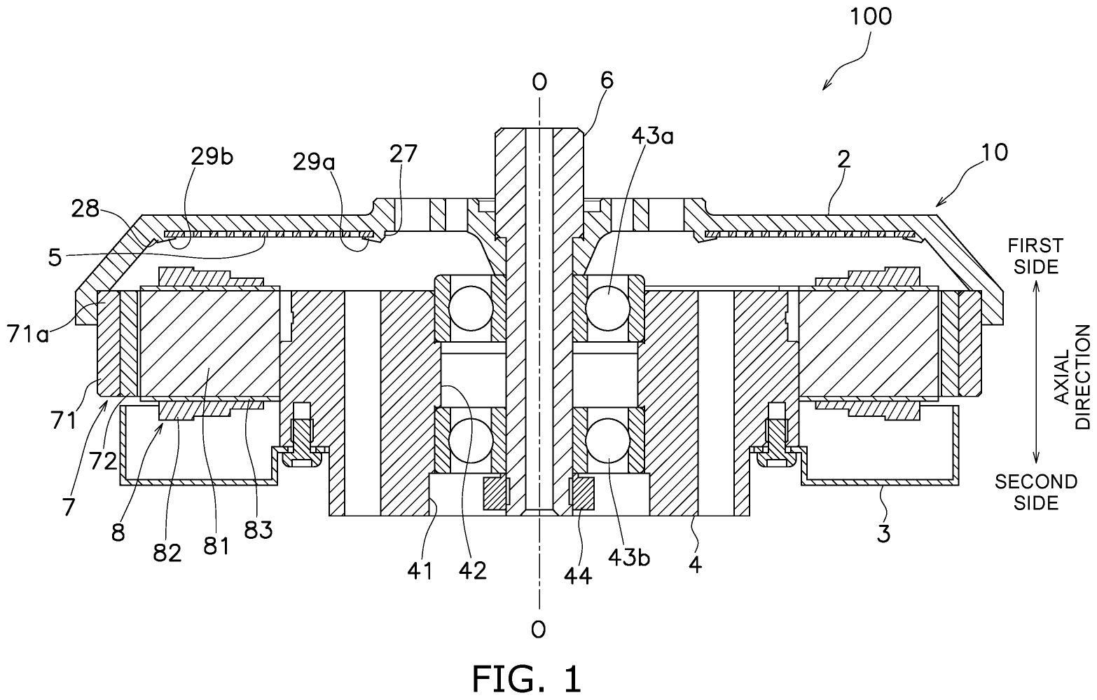

A drone motor (hereinafter simply referred to as “motor” on an as-needed basis) according to a preferred embodiment will be hereinafter explained with reference to drawings. FIG. 1 is a cross-sectional view of a motor. It should be noted that in the following explanation, the term “axial direction” means an extending direction of a rotational axis O of a motor 100. The term “first side in the axial direction” means the upper side in FIG. 1, whereas the term “second side in the axial direction” means the lower side in FIG. 1. Moreover, the term “circumferential direction” means a circumferential direction of an imaginary circle about the rotational axis. The term “radial direction” means a radial direction of the imaginary circle about the rotational axis.

### [Entire Configuration]

As shown in FIG. 1, the motor 100 includes a housing 10, a support frame 4, a punching plate 5, a rotational shaft 6, a rotor 7, and a stator 8. The motor 100 is configured to rotate a propeller of a drone. The rotational axis O of the motor 100 extends in an up-and-down direction. In other words, in the present preferred embodiment, the axial direction means the up-and-down direction. The motor 100 is a drone motor. The motor 100, when described in detail, is used for an industrial drone.

The propeller (not shown in the drawings) of the drone is disposed on the upper side (the first side in the axial direction) of the motor 100. The drone includes a plurality of motors of the same type as the motor 100. In general, the drone includes four motors 100. The motors 100 are attached to a body part of the drone through arms and so forth, respectively. The body part of the drone accommodates a battery, a control unit, and so forth.

### [Housing]

The housing 10 includes a top plate 2 and a bottom plate 3. In the present preferred embodiment, the top plate 2 is disposed to be rotatable, whereas the bottom plate 3 is disposed to be non-rotatable. The top plate 2 is rotated together with both the rotational shaft 6 and the rotor 7. The top plate 2 is made of material such as metal. When described in detail, aluminum alloy, magnesium alloy, or so forth can be employed as the material of the top plate 2. It should be noted that the material, exemplified as the material of the top plate 2, is also usable as that of the bottom plate 3.

### [Top Plate]

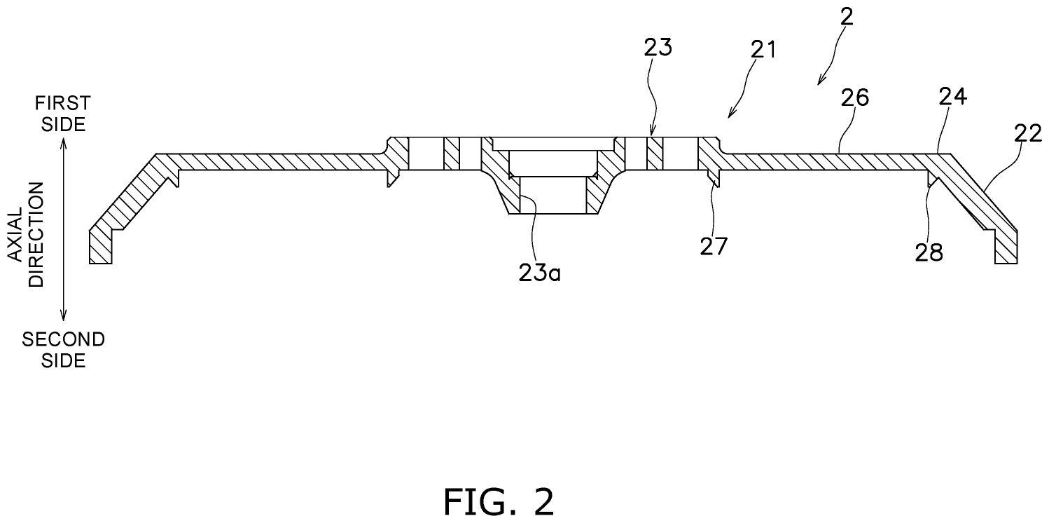

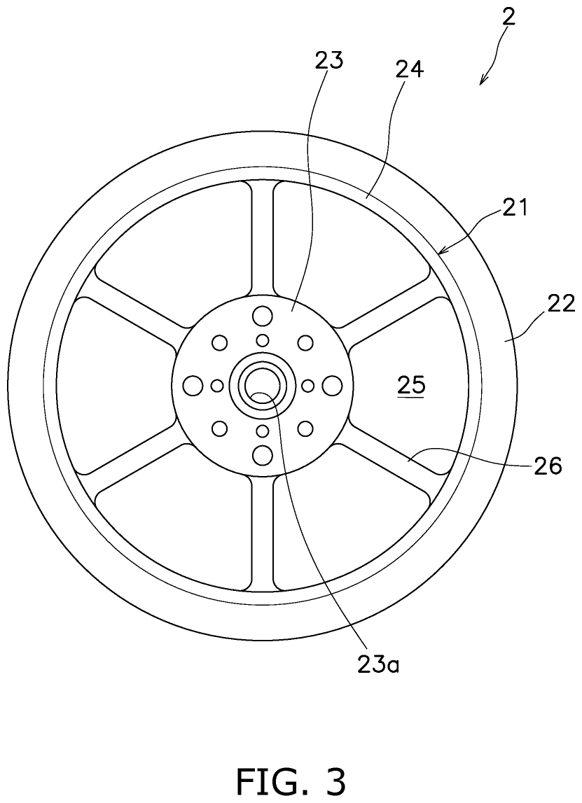

FIG. 2 is a cross-sectional view of the top plate, whereas FIG. 3 is a plan view of the top plate. As shown in FIGS. 2 and 3, the top plate 2 includes a top plate body 21 and an outer cylindrical portion 22. The top plate body 21 includes a middle portion 23, an outer peripheral portion 24, a plurality of openings 25, and a plurality of arms 26.

The middle portion 23 has a disc shape and is provided with a through hole 23a in the middle thereof. The through hole 23a causes the rotational shaft 6 to penetrate the top plate 2 therethrough. The outer peripheral portion 24 has an annular shape and is disposed radially apart from the middle portion 23 at an interval. In other words, the outer peripheral portion 24 is disposed to enclose the middle portion 23.

The plural arms 26 extend from the middle portion 23 in a radial shape. When described in detail, each arm 26 extends in the radial direction. The arms 26 connect the middle portion 23 and the outer peripheral portion 24 therethrough. The arms 26 are disposed apart from each other at intervals in the circumferential direction.

The openings 25 are configured to make the inside and the outside of the housing 10 communicate with each other. Because of this, the air inside the housing 10 can be discharged to the outside through the openings 25. Each opening 25 is disposed circumferentially adjacent two of the plural arms 26. In other words, each opening 25 is defined by a pair of arms 26, the middle portion 23, and the outer peripheral portion 24.

The outer cylindrical portion 22 extends from the outer peripheral portion 24 of the top plate body 21 to the second side in the axial direction. The outer cylindrical portion 22 is provided as a single member integrated with the top plate body 21. The outer cylindrical portion 22 has a taper shape. Specifically, the outer cylindrical portion 22 is shaped to gradually increase in diameter to the second side in the axial direction.

The top plate 2 includes a first cylindrical portion 27 and a second cylindrical portion 28. The first and second cylindrical portions 27 and 28 extend from the top plate body 21 to the second side in the axial direction. The first cylindrical portion 27 extends from the middle portion 23 to the second side in the axial direction. The second cylindrical portion 28 extends from the outer peripheral portion 24 to the second side in the axial direction.

The second cylindrical portion 28 is disposed radially outside the first cylindrical portion 27. In other words, the second cylindrical portion 28 is disposed to enclose the first cylindrical portion 27.

As shown in FIG. 1, the top plate 2 includes a plurality of swaging portions 29a and 29b. When described in detail, the top plate 2 includes a plurality of first swaging portions 29a and a plurality of second swaging portions 29b. The first and second swaging portions 29a and 29b are configured to fix the punching plate 5.

The first swaging portions 29a are disposed apart from each other at intervals in the circumferential direction. Likewise, the second swaging portions 29b are disposed apart from each other at intervals in the circumferential direction. The first swaging portions 29a as well as the second swaging portions 29b are identical in a circumferential position to the arms 26. In other words, the first swaging portions 29a, the second swaging portions 29b, and the arms 26 are equal in number to each other. The first and second swaging portions 29a and 29b overlap with the arms 26 in an axial view.

The first swaging portions 29a are formed by bending, in part, the first cylindrical portion 27 radially outward. On the other hand, the second swaging portions 29b are formed by bending, in part, the second cylindrical portion 28 radially inward.

### [Bottom Plate]

The bottom plate 3 is disposed apart from the top plate 2 at an interval in the axial direction. When described in detail, the bottom plate 3 is disposed on the second side of the top plate 2 in the axial direction. The bottom plate 3 has an annular shape. The bottom plate 3 is fixed at the inner peripheral end thereof to the support frame 4. The bottom plate 3 can be formed by a punching plate, or alternatively, by a normal plate.

### [Support Frame]

The support frame 4 is disposed to be non-rotatable. The support frame 4 is fixed to, for instance, the arms of the body part of the drone. The support frame 4 supports the stator 8. Besides, the support frame 4 supports the rotational shaft 6 such that the rotational shaft 6 is made rotatable.

The support frame 4 includes a through hole 41, extending in the axial direction, in a middle part thereof. Besides, the support frame 4 includes a protruding portion 42 protruding radially inward from the inner wall surface thereof, by which the through hole 41 is defined.

The support frame 4 includes a plurality of bearing members 43a and 43b disposed in the through hole 41. It should be noted that in the present preferred embodiment, a first bearing member 43a and a second bearing member 43b are disposed therein. The first and second bearing members 43a and 43b are disposed apart from each other at an interval in the axial direction. The first bearing member 43a is disposed on the first side of the second bearing member 43b in the axial direction.

The first bearing member 43a is restricted from moving in the axial direction, while being interposed between the protruding portion 42 and the top plate 2. On the other hand, the second bearing member 43b is restricted from moving in the axial direction, while being interposed between the protruding portion 42 and a nut 44. It should be noted that the nut 44 is screwed onto the rotational shaft 6. The support frame 4 supports the rotational shaft 6 through the first and second bearing members 43a and 43b such that the rotational shaft 6 is made rotatable.

The support frame 4 is made of material such as metal. When described in detail, aluminum alloy, magnesium alloy, or so forth can be employed as the material of the support frame 4.

### [Punching Plate]

The punching plate 5 includes a plurality of through holes (hereinafter referred to as “punching holes” on an as-needed basis). The punching plate 5 is attached to the top plate 2 so as to cover the openings 25 of the top plate 2. The punching plate 5 is attached to the inner side of the top plate 2. In other words, the punching plate 5 is disposed on the second side of the top plate 2 in the axial direction. With the punching plate 5 disposed as herein described, a foreign object can be inhibited from intruding into the housing 10. Besides, through the plural punching holes of the punching plate 5, the air can be sucked into the housing 10 for the purpose of cooling or the hot air inside the housing 10 can be discharged to the outside.

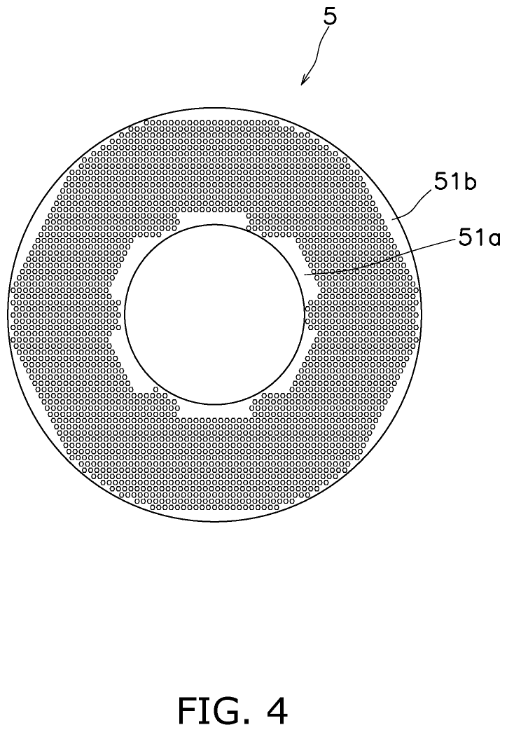

As shown in FIG. 4, the punching plate 5 has an annular shape. The punching plate 5 is lesser in thickness than the top plate 2. The punching plate 5 is made of, for instance, metal or resin. When made of metal, the punching plate 5 is specifically made of stainless steel (SUS), aluminum alloy, or so forth. On the other hand, when made of resin, the punching plate 5 is specifically made of polyphenylene sulfide (PPS), polybutylene terephthalate (PBT), or so forth.

The maximum dimension of each punching hole in the punching plate 5 is less than or equal to the dimension of a gap between the rotor 7 and the stator 8. It should be noted that when each punching hole is made in shape of a polygon such as a rectangle or a hexagon, the maximum dimension of each punching hole is set as the length of the longest diagonal in the polygon. When each punching hole is made in shape of a circle, the maximum dimension of each punching hole is set as the diameter of the circle. The gap between the rotor 7 and the stator 8 means a radial gap therebetween. With the dimensional relations herein set, a foreign object, sized enough to hinder rotation of the rotor 7 by getting stuck in the gap between the rotor 7 and the stator 8, can be inhibited from intruding into the housing 10 through each punching hole.

The punching plate 5 includes a plurality of swaged regions 51a and 51b. When described in detail, the punching plate 5 includes a plurality of first swaged regions 51a and a plurality of second swaged regions 51b.

The first swaged regions 51a are provided in an inner peripheral end portion of the punching plate 5. The first swaged regions 51a are disposed apart from each other at intervals in the circumferential direction.

The second swaged regions 51b are provided in an outer peripheral end portion of the punching plate 5. The second swaged regions 51b are disposed apart from each other at intervals in the circumferential direction.

The first and second swaged regions 51a and 51b are regions not provided with punching holes. The first swaged regions 51a are regions contacted by the first swaging portions 29a. The second swaged regions 51b are regions contacted by the second swaging portions 29b.

The first swaged regions 51a are equal in number to the first swaging portions 29a. Likewise, the second swaged regions 51b are equal in number to the second swaging portions 29b. It should be noted that in the present preferred embodiment, the punching plate 5 includes six first swaged regions 51a and six second swaged regions 51b.

As shown in FIG. 1, the punching plate 5 is disposed radially between the first cylindrical portion 27 and the second cylindrical portion 28. The punching plate 5 is radially set in place by the first and second cylindrical portions 27 and 28. The punching plate 5 is interposed between the arms 26 and both the first swaging portions 29a and the second swaging portions 29b.

### [Rotational Shaft]

The rotational shaft 6 penetrates the top plate 2 so as to axially extend from inside to outside the housing 10. The rotational shaft 6 is rotatably supported by the support frame 4 through the first and second bearing members 43a and 43b.

The propeller is attached to the upper end of the rotational shaft 6. The rotational shaft 6 is fixed to the top plate 2 and is unitarily rotated therewith.

### [Rotor]

The rotor 7 is configured to rotate the rotational shaft 6. The rotor 7 is disposed inside the housing 10. It should be noted that the rotor 7 is exposed in part from the housing 10. The rotor 7 is disposed radially outside the stator 8. In other words, the motor 100 is of an outer rotor type.

The rotor 7 is attached to the top plate 2. In other words, the rotor 7 is rotated unitarily with the top plate 2.

The rotor 7 includes a yoke 71 and a plurality of permanent magnets 72. The yoke 71 has a cylindrical shape. The yoke 71 is fixed to the top plate 2. When described in detail, the yoke 71 is attached to the outer cylindrical portion 22 of the top plate 2. It should be noted that the outer peripheral surface of the yoke 71 is fixed to the inner peripheral surface of the outer cylindrical portion 22.

The yoke 71 is attached to the outer cylindrical portion 22 at a first end 71a thereof, i.e., at an end thereof disposed on the first side in the axial direction. The yoke 71 protrudes from the outer cylindrical portion 22 to the second side in the axial direction. In other words, except for the first end 71a, the remaining part of the yoke 71 is exposed from the housing 10. The yoke 71 functions as part of the housing 10.

The permanent magnets 72 are attached to the inner peripheral surface of the yoke 71. The permanent magnets 72 are disposed apart from each other at intervals in the circumferential direction. The permanent magnets 72 are disposed radially outside the stator 8. In other words, the permanent magnets 72 are disposed to enclose the stator 8. It should be noted that each permanent magnet 72 is disposed radially apart from the stator 8 at an interval.

### [Stator]

The stator 8 is non-rotatably disposed inside the housing 10. The stator 8 is supported by the support frame 4. The stator 8 is disposed radially outside the support frame 4. In other words, the stator 8 is disposed to enclose the support frame 4.

The stator 8 includes a stator core 81 and a plurality of coil portions 82. The stator core 81 is formed by laminating a plurality of electromagnetic steel plates.

The coil portions 82 are wound about the stator core 81. When described in detail, the coil portions 82 are wound about teeth of the stator core 81. It should be noted that an insulating layer 83 is interposed between the coil portions 82 and the stator core 81.

### [Modifications]

One preferred embodiment of the present invention has been explained above. However, the present invention is not limited to the above, and a variety of changes can be made without departing from the gist of the present invention.

(a) In the preferred embodiment described above, the motor 100 is of the outer rotor type, but alternatively, can be of an inner rotor type. In this case, the top plate 2 is disposed to be non-rotatable. Besides, the stator 8 is supported by the top plate 2. Moreover, the support frame 4 is disposed to be rotatable together with the rotational shaft 6. Furthermore, the rotor 7 is supported by the support frame 4.

(b) In the preferred embodiment described above, the punching plate 5 is disposed inside the top plate 2, but alternatively, can be disposed outside the top plate 2.

(c) In the preferred embodiment described above, the rotational shaft 6 is provided as a member separated from the top plate 2. However, the configuration of the rotational shaft 6 is not limited to this. For example, the rotational shaft 6 can be provided as a member integrated with the top plate 2.

### REFERENCE SIGNS LIST

2: Top plate
21: Top plate body
22: Outer cylindrical portion
25: Opening
26: Arm
27: First cylindrical portion
28: Second cylindrical portion
29a, 29b: Swaging portion
5: Punching plate
51a, 51b: Swaged region
6: Rotational shaft
7: Rotor
71: Yoke
72: Permanent magnet
8: Stator
10: Housing
100: Drone motor

What is claimed is:

1. A drone motor comprising:
a housing including a top plate provided with an opening;
a punching plate provided with a plurality of through holes, the punching plate attached to the top plate so as to cover the opening;
a rotor rotatably disposed inside the housing; and
a stator non-rotatably disposed inside the housing.

2. The drone motor according to claim 1, wherein the punching plate is attached to an inner surface of the top plate.

3. The drone motor according to claim 1, wherein the top plate includes a plurality of swaging portions fixing the punching plate.

4. The drone motor according to claim 3, wherein
the top plate includes a plurality of arms radially extending, the plurality of arms circumferentially disposed apart from each other at intervals,
the opening is disposed between circumferentially adjacent two of the plurality of arms, and
the plurality of swaging portions are identical in a circumferential position to the plurality of arms.

5. The drone motor according to claim 3, wherein the punching plate includes a plurality of swaged regions that are not provided with the plurality of through holes formed by punching, the plurality of swaged regions contacted by the plurality of swaging portions.

6. The drone motor according to claim 1, wherein
the top plate includes a first cylindrical portion and a second cylindrical portion, the first cylindrical portion axially extending, the second cylindrical portion axially extending, the second cylindrical portion disposed radially outside the first cylindrical portion, and
the punching plate is disposed between the first cylindrical portion and the second cylindrical portion.

7. The drone motor according to claim 3, wherein
the top plate includes a first cylindrical portion and a second cylindrical portion, the first cylindrical portion axially extending, the second cylindrical portion axially extending, the second cylindrical portion disposed radially outside the first cylindrical portion,
the punching plate is disposed between the first cylindrical portion and the second cylindrical portion, and
the plurality of swaging portions are formed by bending in part at least one of the first cylindrical portion or the second cylindrical portion.

8. The drone motor according to claim 1, wherein the top plate includes a top plate body and an outer cylindrical portion, the top plate body provided with the opening, the outer cylindrical portion axially extending from an outer peripheral end of the top plate body.

9. The drone motor according to claim 8, wherein the outer cylindrical portion has a taper shape.

10. The drone motor according to claim 8, wherein
the rotor includes a yoke and a plurality of magnets, the yoke having an annular shape, the yoke fixed to an inner peripheral surface of the outer cylindrical portion, the plurality of magnets fixed to an inner peripheral surface of the yoke, and
the yoke axially protrudes from the outer cylindrical portion.

11. The drone motor according to claim 1, wherein the punching plate is lesser in thickness than the top plate.

12. The drone motor according to claim 1, wherein the top plate is disposed to be rotatable with the rotor.

13. The drone motor according to claim 1, wherein each of the plurality of through holes of the punching plate has a maximum dimension less than or equal to a dimension of a gap between the rotor and the stator.

14. The drone motor according to claim 1, further comprising:
a rotational shaft penetrating the top plate so as to axially extend from inside to outside the housing.
